(19) United States
(12) Patent Application Publication
(10) Pub. No.: US 2003/0048079 A1
(43) Pub. Date: Mar. 13, 2003

(54) Electric lamp

(76) Inventor: Johannes Maria Josephus Van Lieshout, Eindhoven (NL)

Correspondence Address: U.S. Philips Corporation, 580 White Plains Road, Tarrytown, NY, 10591, US

(21) Appl. No.: 10/227,695

(22) Filed: Aug. 26, 2002

(30) Foreign Application Priority Data
Aug. 30, 2001 (EP) 01203264.5

(51) Int. Cl. H01J 17/16

(52) U.S. Cl. 313/636

(57) ABSTRACT

An electric lamp comprising a lamp vessel (1) which is sealed in a gastight manner to a sleeve (9) by means of a sealing glass (12). The sealing glass (12) comprises, as calculated in % by weight on an oxide basis: 33-70% SiO₂, 10-35% Al₂O₃, 0-10% B₂O₃, 33-70% SiO₂+B₂O₃, 10-35% Al₂O₃+B₂O₃, 0-10% P₂O₅ and finally a 10-40% copperoxide as an infrared absorbing material. The sealing glass (12) has favorable properties which improve the lamp properties, as regards the annealing and softening points of the sealing glass (12) and suppression of a tendency of the sealing glass to devitrify. The risk of devitrification and deterioration of the gastight seal between glass bodies (1, 9) and an untimely failure of the lamp is thus counteracted.

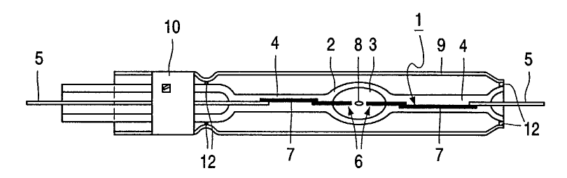

The invention relates to an electric lamp comprising:

a first glass body,

a second glass body being sealed in a gastight manner to the first glass body by means of a sealing glass, the sealing glass comprising an infrared absorbing material.

Such a lamp is known from U.S. Pat. No. 4,328,022. A gastight seal between the reflector body and the lens is required in various lamps for hermetically sealling a concave space enclosed by these glass bodies, thus counteracting oxidation of lamp parts of a lamp vessel arranged in said space. Its alternatively possible to have a (gastight) seal between a lamp vessel and a sleeve, for example for the lamp to be safer with respect to the effects of an explosion of the lamp vessel. Sealing with a sealing glass is a relatively easy and well-known method for joining glass bodies, which generally yields seals with a sufficiently high temperature resistance. Alternative methods for obtaining a gastight seal are, for example, the use of a metal clamping ring, which involves the problem of difficulty in obtaining a gastight seal, and sealing with cement, with the problem of an insufficiently high temperature resistance. In the known lamp, an infraredabsorbing sealing mixture of the sealing glass and corderite is used to join hardglass bodies in a gastight manner, i.e. the reflector body and the lens. The hardglass bodies in general have a coefficient of thermal expansion (CTE) of 30-50*10⁻⁷/° C. The sealing glass is essentially composed of 60-70% ZnO, 10-16% SiO₂, 19-25% B₂O₃ by weights and a rest consisting of the infraredabsorbing material, i.e. copperoxide, and has a CTE of approximately 38*10⁻⁷/° C. This property has led to such sealing glasses being proposed for the joining of bodies made of hard glasses and quartz glasses, although the CTE of the sealing glass does not match CTEs of quartz glasses, i.e. CTEs in the range of 5-15*10⁻⁷/° C. A particular feature is the use of focused infrared heating to soften the sealing mixture to seal the glass bodies. Accordingly, the assembly of glass parts, separated by a layer or layers of a sealing mixture, is heated by exposure to one or more sources of focused infrared radiation. In the known lamp, the sealing is achieved in that infrared radiation is directed through walls of the glass bodies onto the deposited sealing mixture, which is present as a frit layer, the infrared radiation having a focal point or line at the frit layerglass body interface. The infrared radiation is absorbed in the frit layer by the infrared absorbing compound, i.e. iron oxide or copper oxide, of the sealing glass. This causes the sealing glass portion of the mixture to become hot and subsequently to soften and the mixture to flow into a sealing layer of desired geometry, while avoiding undue heating of other parts of the assembly, in particular any thermally sensitive element such as a filament or reflecting film. However, the known infrared absorbing sealing glasses have been found to be of marginal utility. Though they form a rigid, vitreous seal, it is a disadvantage of the known glasses that they crystallize relatively easily during the sealing process and/or during operation of the lamp, thereby deteriorating the seal between the glass bodies. Such deterioration may lead to the seal becoming permeable to gases, i.e. the seal not being gastight anymore, or even to a subsequent disappearance of the seal, so that the lens becomes detached from the reflector body, and to a premature failure of the lamp.

It is an object of the invention to provide an electric lamp of the type described in the opening paragraph in which the disadvantage mentioned above is counteracted. The lamp of the invention is for this purpose characterized in that the sealing glass comprises, as calculated in percents by weight on an oxide basis, 33-70% SiO₂, 10-35% Al₂O₃, 10-40% Cu₂O, 0-10% B₂O₃, 33-70% SiO₂+B₂O₃, 10-35% Al₂O₃+B₂O₃, and 0-10% P₂O₅. The glasses have CTEs below 20*10⁻⁷/° C. over the temperature range of 25-500° C., said CTEs being in the range of the CTEs of quartz glasses and, i.e. glasses with a CTE of approximately 5-15*10⁻⁷/° C., and CTE's of glass-ceramics, i.e. glass-ceramics with a CTE of approximately −5-15*10⁻⁷/° C. Such sealing glasses are accordingly suitable for sealing quartz glass bodies and glass-ceramic bodies, respectively within the compositional area either B₂O₃ or P₂O₅ may be substituted for either Al₂O₃ or SiO₂. The substitution may be in an amount of up to about 10% by weight. Preferably, the substitution is in an amount of 1-4%. Such substitutions have advantageous effects on sealing glass properties, and consequently on lamp properties, in that they lower the annealing and softening points of the sealing glass. They also suppress a tendency of the sealing glass to devitrify. The risk of devitrification and deterioration of the gastight seal between the glass(-ceramic) bodies and premature failure of the lamp is thus counteracted. Furthermore, the sealing glasses of the present invention exhibit softening points below 900° C. Preferred sealing glasses, i.e. when the sealing glass comprises (as calculated in percents by weight on an oxide basis), 43-50% SiO₂, 17-23% Al₂O₃, 29-32% copperoxide, and 1-4% B₂O₃, will have softening points of the order of 800° C. and not above 850° C. Comparatively low sealing temperatures which are easy to control may thus be used. Table 1 shows compositions and properties of several sealing glasses.

TABLE 1

| Oxide wt. %)/ | | | | | | |
|---|---|---|---|---|---|---|
| Property | 1 | 2 | 3 | 4 | 5 | 6 |
| Cu₂O | 31.2 | — | 30.5 | 30.5 | 21.8 | 39.9 |
| CuO | — | 30.3 | — | — | — | — |
| Al₂O₃ | 17.7 | 17.9 | 20.2 | 19.8 | 18.0 | 17.6 |
| B₂O₃ | 2.9 | 2.9 | — | 2.9 | 3.0 | 2.9 |
| P₂O₅ | — | — | 3.0 | — | — | — |
| SiO₂ | 48.0 | 48.7 | 46.3 | 46.9 | 57.2 | 39.6 |
| CTE(*10⁻⁷) | 5.2 | 10.0 | 6.6 | 7.0 | 7.7 | 11.2 |
| Soft. Pt. ° C. | 830 | 747 | 795 | 795 | 866 | 785 |

It is essential for a light source, i.e. a filament or a discharge path, in miniature projection lamps to have an accurately defined position with respect to lightdirecting means, for example a reflector or a lens. Reference points are often provided both on the sleeve and on a socket of said lamp to give the light source said accurately defined position. Therefore, relatively low sealing temperatures are of particular importance for said miniature quartz glass lamps, as the risk of the quartz glass deforming decreases at relatively low temperatures. Hence, the risk of an inaccurate position of the light source path with respect to lightdirecting means is reduced.

In another embodiment of the electric lamp, the sealing glass comprises the copperoxide essentially completely in a cuprous state. The sealing glass in which the copperoxide is in the cuprous state, i.e. in a lower oxidation state of copper, that is the Cu⁺-state. Table 1 gives examples of sealing glasses. As is shown in Table 1, sealing glasses in which the copperoxide is in the cuprous state provide relatively low expansion coefficients over a wide temperature range. Such sealing glasses generally have a CTE of approximately 5-10*10⁻⁷/° C. Such glasses are particularly suitable for the sealing of glass bodies made of quartz glass, i.e. glasses having a SiO₂-content of at least 95% by weight.

JP07-085846 discloses an infraredabsorbing sealing glass having a CTE of about 6*10⁻⁷/° C. The sealing glass has the disadvantage that it crystallizes comparatively easily upon cooling down after operation of the lamp.

The invention is further described and illustrated in the accompanying drawing, in which the FIGURE shows a lamp according to the invention in side elevation.

In the FIGURE, the high-pressure mercury discharge lamp has as a first glass body a lamp vessel 1 made of quartz glass. The lamp vessel 1 has a discharge space 3 enclosed by a wall 2, and is sealed in a gastight manner by mutually opposed seals 4. An electric element 6, in the FIGURE a pair of electrodes defining a discharge path 8, is arranged in the discharge space 3. The pair of electrodes 6 is connected to external current conductors 5 via metal foils 7 embedded in the seals 4. The lamp vessel 1 is enveloped by a second glass body, i.e. a sleeve 9, said sleeve being sealed in a gastight manner onto the lamp vessel 1 by means of a sealing glass 12. The discharge path 8 is accurately positioned with respect to the sleeve 9. Reference means 10 are provided on the sleeve 9 to achieve an accurate positioning of the sleeve with respect to a lamp socket (not shown). The lamp vessel 1 and the sleeve 9 are typical commercial glass bodies, for example made from quartz glass having a SiO₂-content of at least 99.95% by weight and UV-absorbing quartz glass, for example Philips UV-absorbing quartz glass #521, respectively the UV-absorbing quartz glass is essentially composed of, in % by weight on an oxide basis, 99.2% SiO₂, 0.04% TiO₂, 0.17% Al₂O₃ and 0.57% CeO₂, and has a coefficient of thermal expansion (25-300° C.) of approximately 6*10⁻⁷/° C. The sealing glass 12 is present between the lamp vessel 1 and the sleeve 9, such that said glass bodies 1 and 9 are sealed, through infrared heating, in a gastight manner. The glass composition of the sealing glass 12 comprises essentially, in % by weight on an oxide basis, 39.6% SiO₂, 2.9% B₂O₃, 17.6% Al₂O₃ and 39.9% Cu₂O. The sealing glass 12 has a coefficient of thermal expansion (25-500° C.) of approximately 11.2*10⁻⁷/° C. and a softening point of approximately 785° C.

1. An electric lamp comprising:
a first glass body (1),
a second glass body (9) and being sealed in a gastight manner to the first glass body (1) by means of a sealing glass (12), the sealing glass (12) comprising an infraredabsorbing material,
characterized in that the sealing glass (12) comprises, as calculated in percents by weight on an oxide basis, 33-70% SiO₂, 10-35% Al₂O₃, 10-40% copperoxide, 0-10% B₂O₃, 33-70% SiO₂+B₂O₃, 10-35% Al₂O₃+B₂O₃, and 0-10% P₂O₅.

2. An electric lamp as claimed in claim 1, characterized in that the sealing glass (12) has a softening point below 900° C.

3. An electric lamp as claimed in claim 1 or 2, characterized in that the sealing glass (12) comprises, as calculated in percent by weight on an oxide basis, 43-50% SiO₂, 17-23% Al₂O₃, 29-32% copperoxide, and 1-4% B₂O₃.

4. An electric lamp as claimed in claim 1, 2 or 3, characterized in that the copperoxide being is essentially completely in the cuprous state.
